(19) United States
(12) Patent Application Publication
(10) Pub. No.: US 2013/0191568 A1
(43) Pub. Date: Jul. 25, 2013

(54) OPERATING M-PHY BASED COMMUNICATIONS OVER UNIVERSAL SERIAL BUS (USB) INTERFACE, AND RELATED CABLES, CONNECTORS, SYSTEMS AND METHODS

(71) Applicants: Yuval Corey Hershko, (US); Yoram Rimoni, (US)

(72) Inventors: Yuval Corey Hershko, (US); Yoram Rimoni, (US)

(73) Assignee: QUALCOMM Incorporated, San Diego, CA (US)

(21) Appl. No.: 13/356,521

(22) Filed: Jan. 23, 2012

(51) Int. Cl. G06F 13/42

(52) U.S. Cl. 710/106

(57) ABSTRACT

Operating M-PHY communications protocol over a USB interface and related devices, systems, and methods are disclosed. In one embodiment, an electronic device is configured to operate using a M-PHY standard. The device comprises a communications interface having a plurality of data paths conforming to the M-PHY standard and a USB connector having a plurality of pins. The plurality of pins comprises a first receive pin electrically coupled to a M-PHY RXDN data path of the communications interface. The plurality of pins comprises a second receive pin electrically coupled to a M-PHY RXDP data path of the communications interface. The plurality of pins comprises a first transmit pin electrically coupled to a M-PHY TXDN data path of the communications interface and a second transmit pin electrically coupled to a M-PITY TXDP data path of the communications interface. Additionally, various methods of insertion detection and power delivery are disclosed.

### BACKGROUND

I. Field of the Disclosure

The technology of the present disclosure relates generally to communications interfaces used for communications between electronic devices.

II. Background

Electronic devices have proliferated throughout society supporting a wide range of applications and uses. As the number and variety of devices expands, there is an increasing need for electronic devices to communicate with one another. In response to this need, various protocols have been proposed and adopted. In many instances, the protocols define signal levels, and associated data representations and timing that are communicated between the electronic devices. Examples of these protocols include wireless communications, such as the WEE 802.11 standards and BLUETOOTH®, Wireless signal protocols may also specify frequency and power levels. Others of these protocols are wire-based. In the event that a protocol is wire-based, a standardized physical connector may be required to effectuate communications between the devices. Various physical connectors, for example RJ-11, RJ-14, RJ-45, and RJ-49, have been used successfully for various purposes and protocols.

With the explosion of mobile platform devices, and the increased functionality in each of these devices, data rules between peripherals have seen exponential growth in this regard the MIPI® Alliance has recently proposed the M-PHY^{SM} physical layer standard defining a data rate of 10 Kbps to 5.8 Gbps per lane. The M-PHY standard is optimized for mobile applications, such as cameras, displays for mobile terminals, smart phones, and the like. However, while the M-PHY standard provides a serial interface technology with high bandwidth capabilities, the M-PHY specification deliberately avoids connector definitions and advocates for a permanent trace based connection between devices. Permanent trace based connections eliminates the flexibility of user desired connections.

### SUMMARY OF THE DISCLOSURE

Embodiments disclosed in the detailed description include operating the M-PHY communications over a universal serial bus (USB) interface, and related cables, connectors, systems, and methods. In particular, embodiments of the present disclosure take the M-PHY standard compliant signals and direct them through a USB compliant connector (and optionally cable) so as to allow two M-PHY standard compliant devices having USB connectors to communicate. In this regard, in an exemplary embodiment, an electronic device is configured to operate using the M-PHY standard. The electronic device comprises a communications interface having a plurality of data paths conforming to the M-PHY standard and a USB connector having a plurality of pins. The plurality of pins of the USB connector comprises a first receive pin electrically coupled to a M-PHY RXDN data path of the communications interface, and a second receive pin electrically coupled to a M-PHY RXDP data path of the communications interface. The plurality of pins also comprises a first transmit pin electrically coupled to a M-PHY TXDN data path of the communications interface, and a second transmit pin electrically coupled to a M-PHY TXDP data path of the communications interface.

In another embodiment, a method of connecting an electronic device, configured to operate using the M-PHY standard, to a second electronic device, is provided. The method comprises providing a plurality of data paths conforming to the M-PHY standard and providing a USB connector having a plurality of pins. The method comprises electrically coupling a first receive pin to a M-PHY RXDN data path and electrically coupling a second receive pin to a M-PHY RXDP data path. The method comprises electrically coupling a first transmit pin to a M-PHY TXDN data path of the communications interface and electrically coupling a second transmit pin to a M-PHY TXDP data path of the communications interface.

### BRIEF DESCRIPTION OF THE FIGURES

FIG. 1A is a block diagram of an exemplary conventional direct mated universal serial bus (USB) connection between a host and other device;

FIG. 1B is a block diagram of an exemplary conventional cable mated USB connection between a host and other device;

FIG. 1C is a perspective view of a conventional USB Standard-A connector;

FIG. 2 is a table illustrating an exemplary mapping of USB pins of a USB connector to a M-PHY data path for a M-PHY standard;

FIG. 3 is a block diagram of an exemplary embodiment of a conventional M-PHY single lane signal path layout for connection of M-PHY standard compliant electronic devices;

FIG. 4 is a flowchart illustrating an exemplary process for mapping USB pins of a USB connector to M-PHY standard data paths;

FIG. 5 illustrates an exemplary embodiment of a particular configuration of a mapping of USB pins of a USB connector to M-PHY standard signals;

FIG. 6 illustrates an alternate embodiment of a particular configuration of a mapping of USB pins of a USB connector to M-PHY standard signals;

FIG. 7 illustrates an alternate embodiment of a particular configuration of a mapping of USB pins of a USB connector to M-PHY standard signals; and

FIG. 8 is a block diagram of an exemplary processor-based system that can include a USB connector having USB pins mapped to a M-PHY standard data paths.

### DETAILED DESCRIPTION

With reference now to the drawing figures, several exemplary embodiments of the present disclosure are described. The word “exemplary” is used herein to mean “serving as an example, instance, or illustration.” Any embodiment described herein as “exemplary” is not necessarily to be construed as preferred or advantageous over other embodiments.

Embodiments disclosed in the detailed description include operating the M-PHY communications over a universal serial bus (USB) interface, and related devices, systems, and methods. In particular, embodiments of the present disclosure take the M-PHY standard compliant signals and direct them through a USB compliant connector (and optionally cable) so as to allow two M-PHY standard compliant devices having USB connectors to communicate. In this regard, in an exemplary embodiment, an electronic device is configured to operate using the M-PHY standard. The electronic device comprises a communications interface having a plurality of data paths conforming to the M-PHY standard and a USB connector having a plurality of pins. The plurality of pins of the USB connector comprises a first receive pin electrically coupled to a M-PHY RXDN data path of the communications interface, and a second receive pin electrically coupled to a M-PHY RXDP data path of the communications interface. The plurality of pins also comprises a first transmit pin electrically coupled to a M-PHY TXDN data path of the communications interface, and a second transmit pin electrically coupled to a M-PHY TXDP data path of the communications interface.

The MIPI® Alliance has proposed the M-PHY standard, which is a physical layer protocol detailing how devices communicate with one another. However, the MIPI® Alliance has to date, not defined or constrained the M-PHY standard to a particular connector type that complies with the standard, leaving the design of the physical connectors to the entities deploying products in this space. While it is possible to design such a physical connector without reference to any existing connector type, an existing connector is adapted herein to satisfy the signal integrity and other requirements of the MIPI® Alliance M-PHY standard, namely the USB connector currently used for USB protocol compliant devices. As a non-limiting example, the USB connector that is adapted to be used for the MIPI® Alliance M-PHY standard standard can be a USB 3.0 connector.

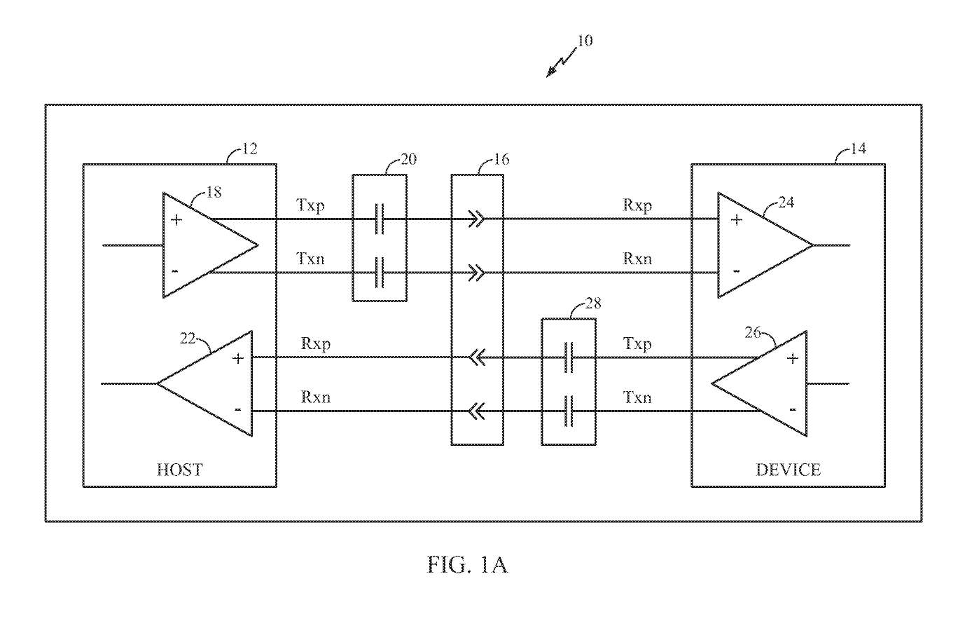

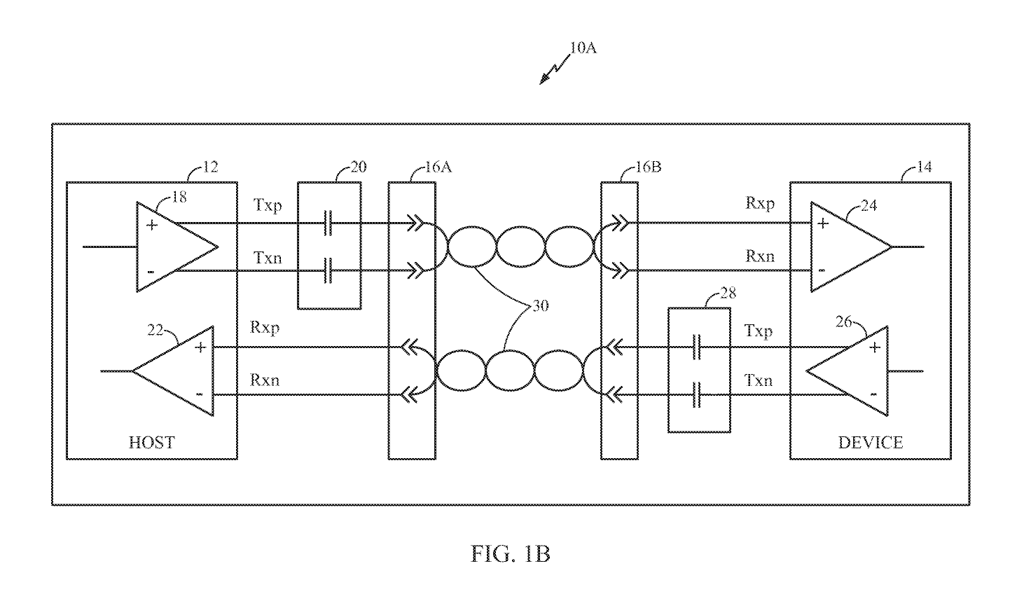

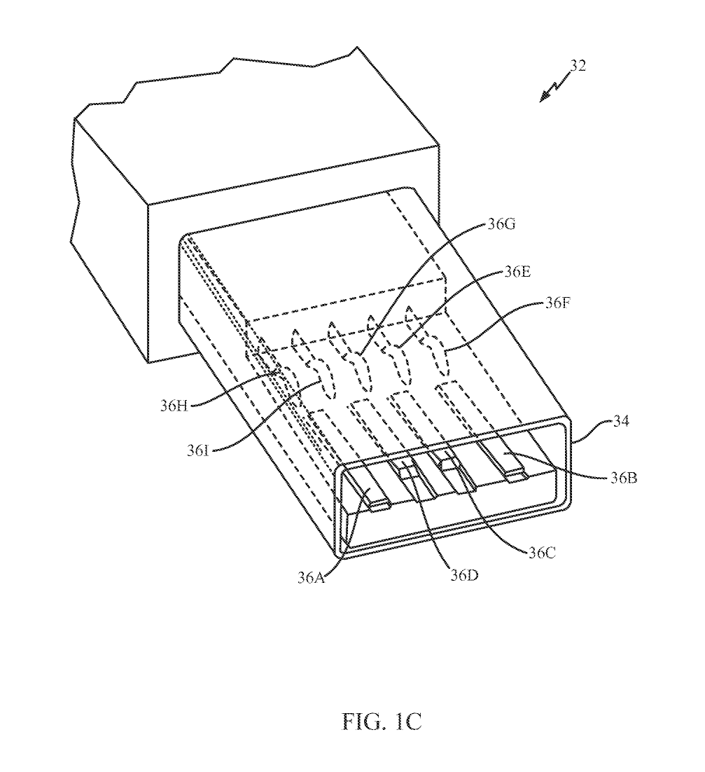

USB is an industry standard introduced in the mid 1990s. USB 3.0 was subsequently introduced in 2008. More information on the conventional USB 3.0 standard and connectors can be found at www.usb.org/developers/docs/ and in particular, in the Universal Serial Bus Revision 3.0 Specification published on the website, the contents of which are hereby incorporated herein by reference in its entirety. Before discussing the embodiments of adapting the USB connector to the M-PHY standard, USB connectors are first discussed with regard to FIGS. 1A-1C.

FIG. 1A is an exemplary block diagram of a conventional USB connection 10. In this exemplary embodiment, the USB connection 10 is USB 3.0 compliant and includes a host 12 and a device 14. The device 14 is directly plugged into the host 12 through a mated connector 16. The host 12 includes a transmitter with an amplifier 18, filtering capacitors 20, and a receiver with amplifier 22. The device 14 similarly has a receiver with amplifier 24, a transmitter with amplifier 26 and filtering capacitors 28. Following the published USB protocol, the host transmitter sends TXP and TXN signals to the device 14, which treats the incoming signals as RXP and RXN signals respectively. Similarly, the device transmitter sends TXP and TXN signals to the host 12, which treats the incoming signals as RXP and RXN signals respectively. A non-limiting example of this arrangement might be a FLASH memory stick (device 14) inserted into a USB port on a computer (host 12).

FIG. 1B illustrates a USB connection 10A similar to the USB connection 10 in FIG. 1A. However, instead of the mated connector 16, the host 12 may include a connector 16A, and the device 14 includes a connector 16B with a cable 30 extending therebetween. It should be appreciated that connector 16A may be a mated connection, with a connector on the host 12 and a connector on the cable 30 and the connector 16B may similarly be a mated connection, with a connector on the device 14 and a connector on the cable 30. A non-limiting example of this arrangement might be a camera (device 14) being plugged into a computer (host 12) through a USB cable (cable 30). While not illustrated, another possibility does exist. That other possibility is a cable with a connector at one end and “hard wired” to the device at the other end. An example would be a USB computer mouse, which has a cable that is hard-wired to the mouse on one end, and has a Standard-A plug on the other end.

FIG. 1C is a perspective view of an exemplary conventional connector plug 32 that is compliant with USB 3.0. As illustrated, the connector plug 32 is consistent with USB 3.0 Standard-A Plug, but Standard-A receptacles, Standard-B plug and receptacle, Micro-A Plug and receptacle, Micro-B Plug and receptacle, and Micro-AB receptacle share the majority of the same features, although the Micro set of connectors do not support the pin staggering outlined below. In particular, the connector plug 32 includes ten conductive elements. An outer grounding shell 34 is a first conductive element, and nine pins 36A-36I (collectively: pins 36) form the remainder of the ten conductive elements. As defined by the USB 3.0 standard, the names and uses of the outer grounding shell 34 and the pins 36A-36I are summarized in TABLE 1 set forth below. Note that TABLE 1 is specifically set forth with reference to a Standard-A connector, although similar tables are readily available for the other connectors. Additionally, the reference number for the present disclosure is included in TABLE 1 set forth below.

TABLE 1
Conventional USB Standard-A Connector
Pin Assignment and Mating Sequence

| USB 3.0 | Disclosure | USB 3.0 | USB 3.0 | Mating |
|---|---|---|---|---|
| PIN # | # | Signal Name | Description | Sequence |
| 1 | 36A | VBUS | Power Supply | Second |
| 2 | 36B | D− | USB 2.0 | Third |
| 3 | 36C | D+ | Differential Pair | |
| 4 | 36D | GND | Ground for power | Second |
| 5 | 36E | StdA_SSRX− | SS receiver | Last |
| 6 | 36F | StdA_SSRX+ | differential pair | |
| 7 | 36G | GND_DRAIN | Ground for signal | |
| 8 | 36H | StdA_SSTX− | SS transmitter | Last |
| 9 | 36I | StdA_SSTX+ | differential pair | |
| Shell | 34 | Shield | Connector metal | First |
| | | | shield | |

The arrangement of the outer grounding shell 34 and pins 36A-36I (at least in Standard-A plugs and receptacles), and, in particular, the physical geometries associated with the outer grounding shell 34 and pins 36A-36I, causes a particular mating sequence when the connector plug 32 is mated. That is, when the connector plug 32 is inserted into a receptacle, the outer grounding shell 34 is exterior to the pins 36A-36I and extends further than any of the pins 36A-36I, and thus makes the first electrical connection with its counterpart in the receptacle. Subsequently, the pins 36A and 36D make an electrical connection because they extend further forward than any other pin 36. Subsequently, the pins 36B and 36C make the third round of electrical connections, and pins 36E-36I make the last round of electrical connections. This sequence is summarized in the “Mating Sequence” column in Table 1. The present disclosure allows for use of this mating sequence as explained in greater detail below.

Because the USB standard is several years old, the industry has had time to develop a standardized connector plug 32 (illustrated in FIG. 1C). There are numerous manufacturers capable of manufacturing USB 3.0 compliant connectors according to the well established form factor. Likewise, stress and bend tolerances and other fatigue related tolerances and the like are well understood by those who use such connectors. Many specific definitions and requirements are set forth in the USB specification, chapter 5, and the industry has acclimated to meeting these definitions and requirements.

The present disclosure takes advantage of the familiarity with which industry treats the USB 3.0 connectors and particularly with plug 32 (and corresponding receptacles) and proposes repurposing such connectors for use with M-PHY standard compliant devices. In particular, use of the existing USB 3.0 connector in an M-PHY standard compliant device allows all the expertise and familiarity the industry has with the USB 3.0 connector to be leveraged into ready acceptance of its use with M-PHY standard compliant devices. The well-developed manufacturing base allows for ease in securing the connectors for incorporation into M-PHY standard compliant devices. That is, there will be little or no lag time in securing an acceptable manufacturer of connectors for ready inclusion in M-PHY standard compliant devices and the competition between existing manufacturers means that the cost of the individual connectors will likely be reasonable. Similarly, because the connectors are currently made in high volumes, there may be reductions in cost because of appropriate economies of scale.

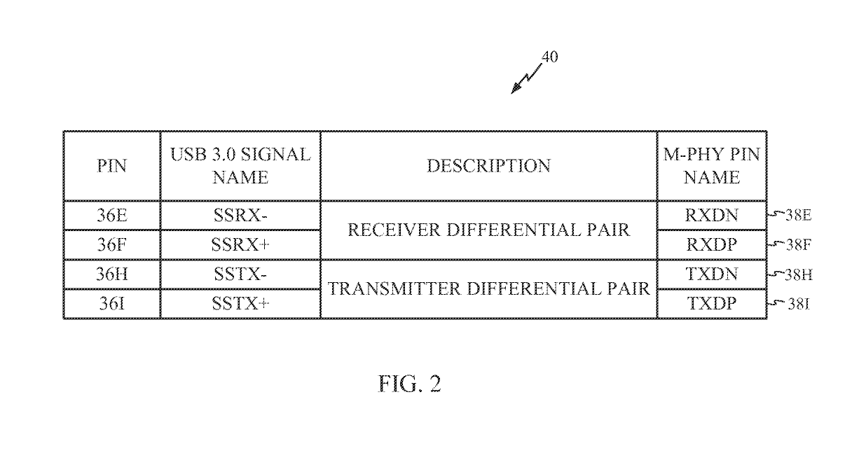

With reference to FIG. 2, the chart 40 illustrates the mapping of the M-PHY standard compliant pin names to the corresponding USB 3.0 signal. In particular, FIG. 2 illustrates that pins 36E, 36F, 36H, and 36I are repurposed from their respective USB signal use to a corresponding M-PHY signal use. Thus, in embodiments of the present disclosure, pin 36E, which was used for the SSRX− signal is used for the RXDN signal 38E; the SSRX+ signal is used for the RXDP signal 38F; the SSTX− signal is used for the TXDN signal 38H; and the SSTX+ signal is used for the TXDP signal 38I. In both the USB standard and the usage proposed herein, the pins 36E, 36F, 36H, and 36I are used for a receiver differential pair and transmitter differential pair as noted.

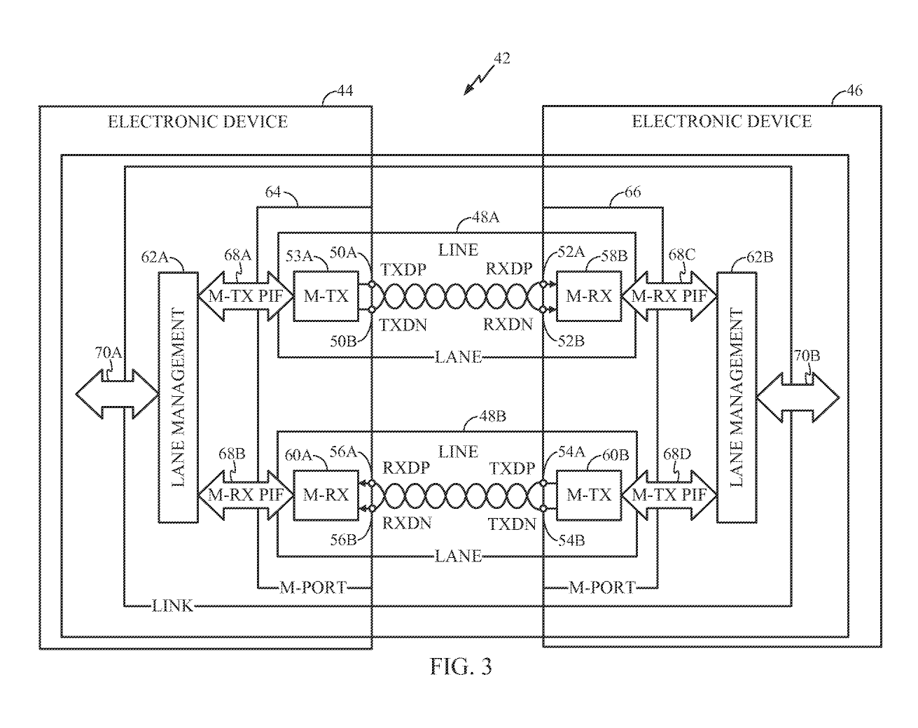

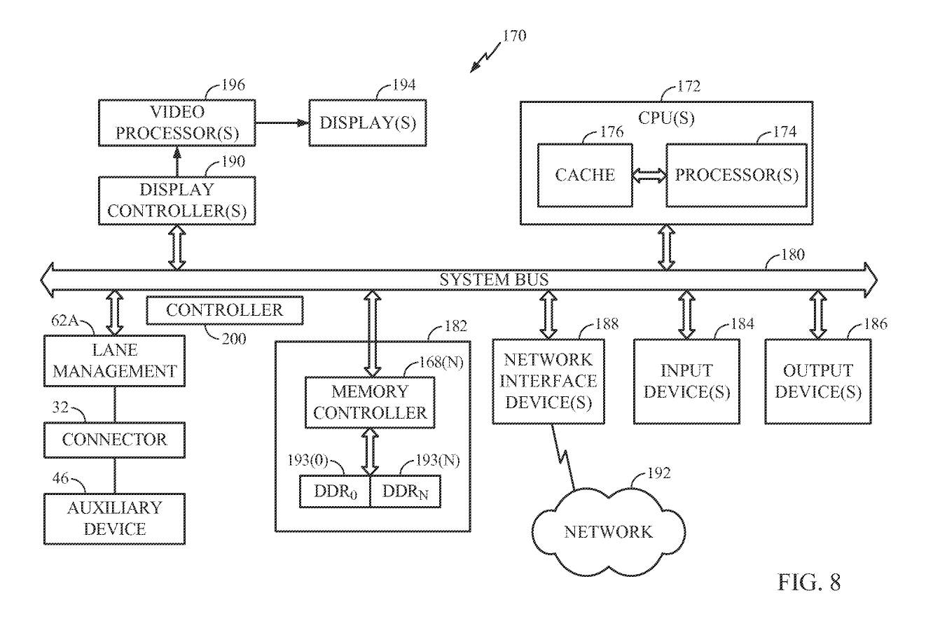

An exemplary conventional M-PHY signal path layout 42 with pin requirements is provided with reference to FIG. 3. That is, a first electronic device 44 is connected to a second electronic device 46. The first electronic device 44 can include a control system or processor (discussed below in regard to FIG. 8), which may, through appropriate device drivers, control the signal lanes 48A, 48H of a communications interface (sometimes referred to herein as a means for interfacing) according to the M-PHY standard. The signal lane 48A is the lane through which the first electronic device 44 transmits data to the second electronic device 46 through the TXDP and TXDN pins 50A, 50B to RXDP and RXDN pins 52A, 52B. Likewise, the second electronic device 46 transmits data to the first electronic device 44 through the TXDP and TXDN pins 54A, 54B to RXDP and RXDN pins 56A, 56B. Each electronic device 44, 46 has its own respective transmitter M-TX 58A, 58B and receiver M-RX 60A, 60B controlled by respective lane management module 62A, 62B. The lane management modules 62A, 62B may be hardware or software or a mix of the two as desired and may communicate with the control system via links 70A, 70B. The pins 50A, 50B, 56A, 56B may be in a single M-Port 64, while the pins 52A, 52B, 54A, and 54B may be in a second M-Port 66. The lane management module 62A may communicate with the transmitter 58A through a peripheral interchange format (PIF) link 68A and with the receiver 60A through a PIF link 68B. Likewise, the lane management module 62B may communicate with the transmitter 58B through a PIF link 68C and the receiver 60B through a PIF link 68D. The lane management modules 62a, 62B, the links 70A, 70B, the transmitters 58A, 60B, receivers 58B, 60A, and PIF links 68A-68D are set forth in the M-PHY standard, and the interested reader is directed thereto for more information regarding these elements. As illustrated, the first electronic device 44 is directly connected to the second electronic device 46. While not explicitly illustrated, it should be appreciated that the direct connection could be replaced by a connector, cable, or combination. Again, the signals and lane management elements are defined by the M-PHY standard, but the arrangement of the pins and any connectors is left undefined. However, as noted with reference to FIG. 2, a USB connector 32 may be repurposed by mapping the pins 36E, 36F, 36H, and 36I to the RXDN 38E, RXDP 38F, TXDN 38H, and TXDP 38I respectively without requiring any physical changes to the connector 32. In this regard, the connector 32 may sometimes be referred to herein as a means for connecting.

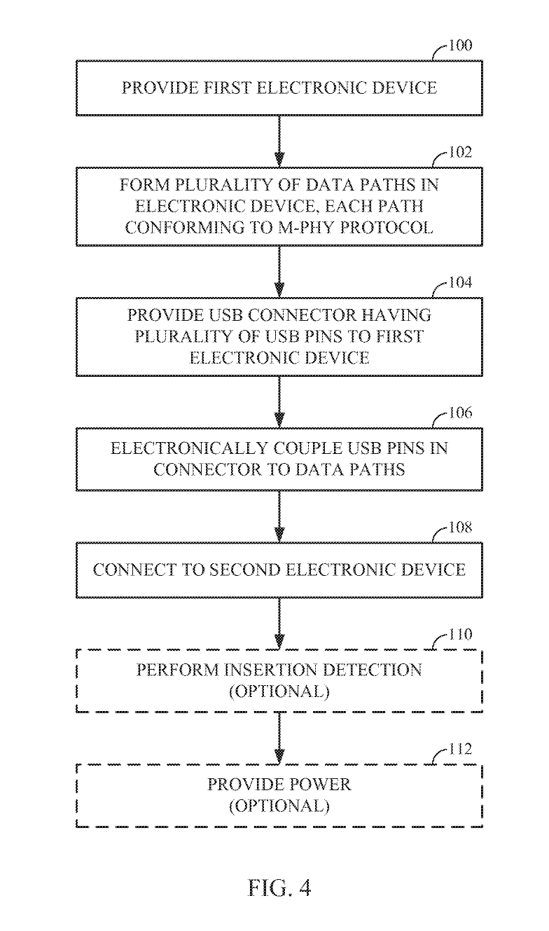

Turning to FIG. 4, a flow chart is provided illustrating a method of connecting a first electronic device, such as electronic device 44, configured to operating using a M-PHY standard to a second electronic device, such as electronic device 46 through a mated connection, a cable with mated connectors or the like. Initially, the method provides an electronic device (block 100) and forms a plurality of data paths in the electronic device, wherein each path conforms to M-PHY standard. (block 102). The method provides a USB connector (e.g., a plug or a receptacle) having a plurality of pins to the electronic device (block 104). In an exemplary embodiment, the USB connector is a USB plug that conforms to the USB 3.0 Standard-A with the outer grounding shell 34 and pins 36A-36I described above, with reference to FIG. 1C and TABLE 1. In alternate embodiments, a Standard B, Micro-A, or Micro-B connector (plugs or receptacles) may be used without departing from the teachings of the present disclosure.

With continued reference to FIG. 4, the method electrically couples the pins in the connector to the data paths (block 106). In an exemplary embodiment, the pins 36A-36I are mapped by electrically coupling a first receive pin (e.g., the SSRX+) to a M-PHY RXDN data path, electrically coupling a second receive pin (e.g., the SSRX−) to a M-PHY RXDP data path, electrically coupling a first transmit pin (e.g., the SSTX−) to a M-PHY TXDN data path, and electrically coupling a second transmit pin (e.g., SSTX+) to a M-PHY TXDP data path.

With continued reference to FIG. 4, and with the data paths connected to the respective pins 36 in the connector 32, the electronic device may be connected to a second electronic device (e.g., second device 46) (block 108). During connection or shortly thereafter, the control system associated with the connector may perform insertion detection (block 110) and/or provide power (block 112) to the second electronic device 46.

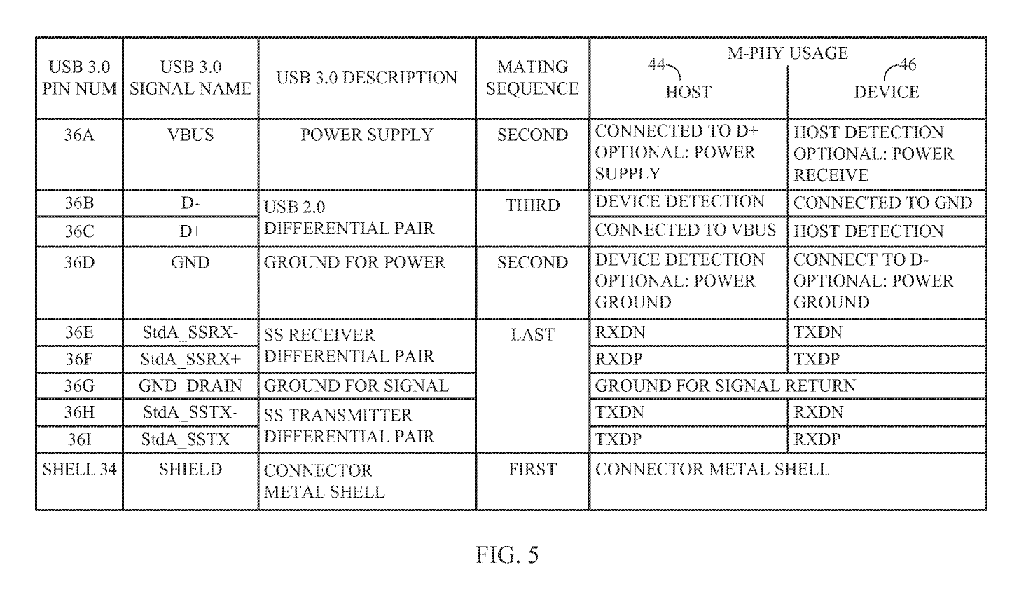

Using the USB connector plug 32 allows for insertion detection and provides the ability to supply power to the second electronic device 46. Insertion detection allows the first electronic device 44 to know when it is acceptable to send data or listen for data from the second electronic device 46. Likewise, the second electronic device 46 should detect that the first electronic device 44 has been connected. Other advantages may also be realized through insertion detection, and the present disclosure is not so limited. Likewise, providing power to the second electronic device 46 allows the designers to avoid having to provide a power cord or alternate power source for the second electronic device. There are a number of possible configurations which would allow this to happen. Three exemplary configurations using USB Standard-A connectors (plugs, receptacles and/or cables) are illustrated in FIGS. 5-7.

With reference to FIG. 5, the first electronic device 44 is considered the host device and the second electronic device 46 is considered the auxiliary device. Note that while USB defines a host and a device (referred to herein as the host device and the auxiliary device), M-PHY does not make this distinction, although it is preserved in the present disclosure to facilitate the explanation. In the host device 44, pin 36A, which in the USB 3.0 standard is the VBUS signal, is connected to pin 36C, which in the USB 3.0 standard is the D+ signal. Pins 36B and 36D may be used for insertion detection. Power may be supplied through the pins 36A and 36D. As described above, pins 36E, 36F, 36H, and 36I are used for the data lanes of the M-PHY standard.

With continued reference to FIG. 5, in the auxiliary device 46, the pin 36B may be connected to pin 36D. The auxiliary device 46 may detect insertion based on whether the auxiliary device 46 has power. The host device 44 detects insertion by detection of DC levels. When the connector is mated, the D− pin is pulled to GND potential and the D± pin in the auxiliary device is pulled to VBUS potential. Trivial electronic circuitry could detect that a pin potential has changed from a floating (unconnected) value to either GND or VBUS potential. Thus, no AC signal needs to be injected and the already available DC voltages are reused. This configuration allows for use of a USB 3.0 Standard A connector and is appropriate for use when it is uncertain whether the auxiliary device 46 needs to draw power. Thus, with a relatively simple circuit driving selected pins 36 of the connector 32, both the first electronic device 44 and the second electronic device 46 can detect insertion and the first electronic device 44 can provide power as desired. Note also that the process can be effectively reversed to detect disconnection. That is, if the signals that are detected during insertion are lost, then the devices may infer disconnection.

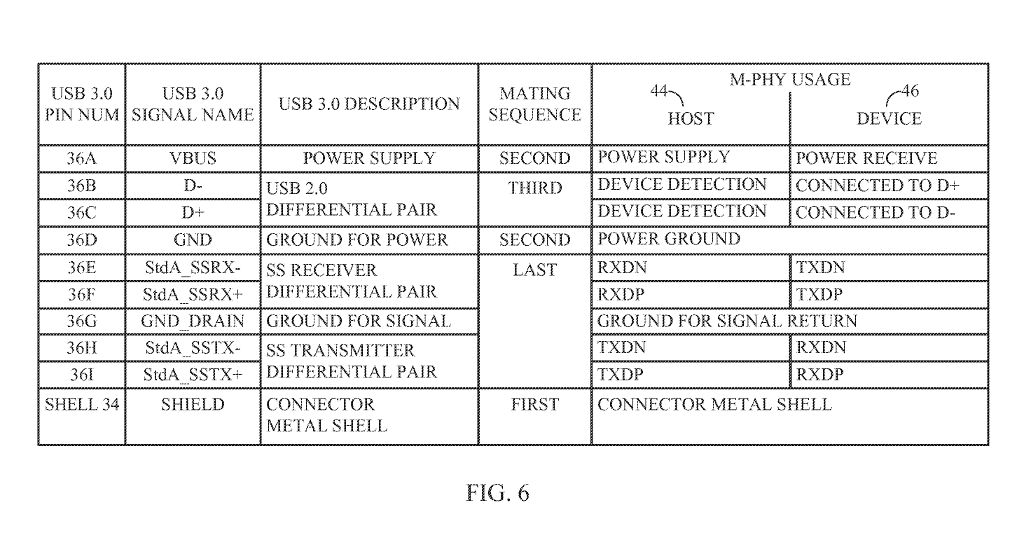

A second exemplary configuration is illustrated in FIG. 6. Again, power is supplied from the host device (first electronic device 44) to the auxiliary device (second electronic device 16) through the pins 36A and 36D. In the auxiliary device 46, pins 36B and 36C are connected to one another. The host device 44 may send a signal, which may just be a DC voltage reference, on pin 36B and, if the signal is received by the host device 44 at pin 36C, the host device 44 ascertains insertion. The auxiliary device 16 ascertains insertion by the reception of power from pins 36A and 36D. This configuration is likewise well suited for use with a USB 3.0 Standard A connector.

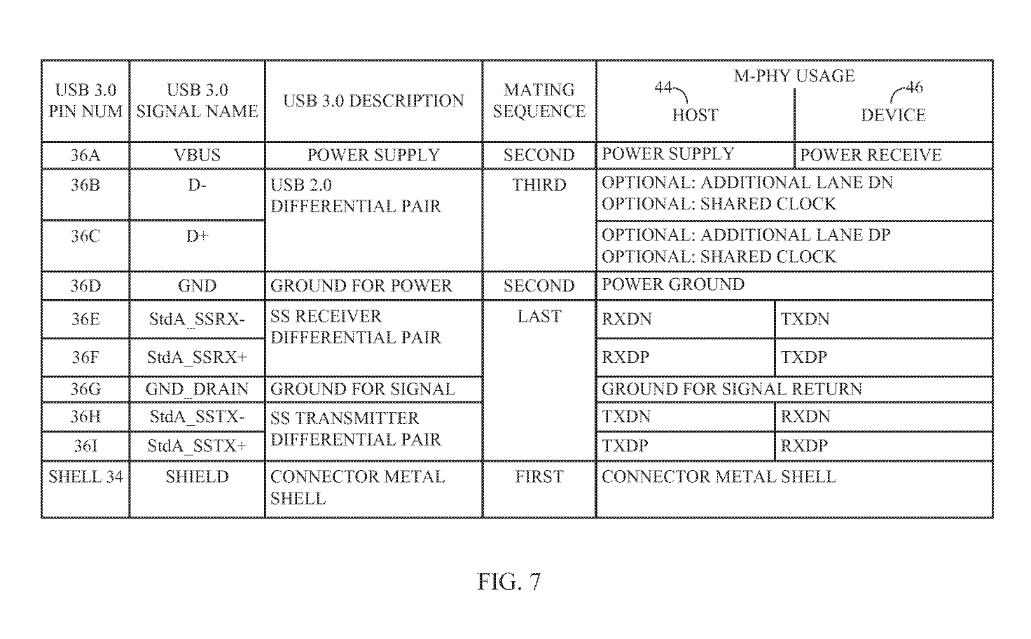

A third exemplary configuration is illustrated in FIG. 7. Power is again supplied from the host device (first electronic device 44) to the auxiliary device (second electronic device 36) through the pins 36A and 36D. Pins 36B and 36C may be used to support an additional data lane (either in the forward or reverse direction) or a shared clock as needed or desired. In this embodiment, the auxiliary device 46 sinks power. For this configuration, the power sinking may be a requirement for the auxiliary device 46 to draw a minimal current for a specific period. (e.g., must draw a current of no less than 10 mA for no less than 2 seconds after power is applied). The host device 44 may include circuitry to detect this power sink. The provision of power to the auxiliary device 46 allows the host 44 to detect insertion. This configuration allows use of a USB 3.0 Standard A connector, a standard B connector, as well as Micro-A and Micro-B connectors because this configuration does not rely on the four phase insertion that is used in the other configurations. If additional data bandwidth is required, then the additional lane may be a data lane. However, if the auxiliary device 46 needs to synchronize with some other element, the clock signal may be used. Note that the first two configurations (FIGS. 5 and 6) described above do not support such a clock signal and thus are appropriate for use with M-PHY Type-I. The third configuration of FIG. 7 allows for a shared clock, and thus supports M-PHY Type II. Still other uses for this lane may be provided.

Depending on the quality of the connector and cable (if present) the data lane formed from pins 36B and 36C may not support high data rates. This distinction results from the quality of the shielding and the physical geometries of the pins. However, even if the quality of the connector and the cable does not support high data rates, the data lane formed from pins 36B and 36C is still usable for low data rates, such as the M-PHY LS-MODE PWM data rate.

The operation of the M-PHY communications protocol over a USB interface and related devices, systems, and methods, according to embodiments disclosed herein, may be provided in or integrated into any processor-based device. Examples, without limitation, include a set top box, an entertainment unit, a navigation device, a communications device, a fixed location data unit, a mobile location data unit, a mobile phone, a cellular phone or smart phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player.

In this regard, FIG. 8 illustrates an example of a processor-based system 170 that can employ the connector plug 32 illustrated in FIG. 1C (or other USB compliant plug or receptacle), with the mapping of FIG. 2 (in any of the configurations set forth above or other comparable configurations tailored to a different plug or receptacle) applied thereto. A controller 200 interoperates with the lane management module 62A as illustrated. In this example, the processor-based system 170 includes one or more central processing units (CPUs) 172, each including one or more processors 174. The CPU(s) 172 may be a master device. The CPU(s) 172 may have cache memory 176 coupled to the processor(s) 174 for rapid access to temporarily stored data. The CPU(s) 172 is coupled to a system bus 180 and can intercouple master devices and slave devices included in the processor-based system 170. The system bus 180 may be a bus interconnect. As is well known, the CPU(s) 172 communicates with these other devices by exchanging address, control, and data information over the system bus 180. For example, the CPU(s) 172 can communicate bus transaction requests to the memory controller 168(N) as an example of a slave device. Although not illustrated in FIG. 8, multiple system buses 180 could be provided, wherein each system bus 180 constitutes a different fabric.

Other master and slave devices can be connected to the system bus 180. As illustrated in FIG. 8, these devices can include a memory system 182, one or more input devices 184, one or more output devices 186, one or more network interface devices 188, and one or more display controllers 190, as examples. The input device(s) 184 can include any type of input device, including but not limited to input keys, switches, voice processors, etc. The output device(s) 186 can include any type of output device, including but not limited to audio, video, other visual indicators, etc. The network interface device(s) 188 can be any devices configured to allow exchange of data to and from a network 192. The network 192 can be any type of network, including but not limited to a wired or wireless network, private or public network, a local area network (LAN), a wide local area network (WLAN), and the Internet. The network interface device(s) 188 can be configured to support any type of communication protocol desired. The memory system 182 can include one or more memory units 193(0-N). The arbiter may be provided between the system bus 180 and master and slave devices coupled to the system bus 180, such as, for example, the memory units 193(0-N) provided in the memory system 182.

The CPU 172 may also be configured to access the display controller(s) 190 over the system bus 180 to control information sent to one or more displays 194. The display controller(s) 190 sends information to the display(s) 194 to be displayed via one or more video processors 196, which process the information to be displayed into a format suitable for the display(s) 194. The display(s) 194 can include any type of display, including but not limited to a cathode ray tube (CRT), a liquid crystal display (LCD), a plasma display, etc.

The CPU(s) 172 and the display controller(s) 190 may act as master devices to make memory access requests to an arbiter over the system bus 180. Different threads within the CPU(s) 172 and the display controller(s) 190 may make requests to the arbiter. The CPU(s) 172 and the display controller(s) 1.90 may provide the MID to the arbiter, as previously described, as part of a bus transaction request.

Those of skill in the art would further appreciate that the various illustrative logical blocks, modules, circuits, and algorithms described in connection with the embodiments disclosed herein may be implemented as electronic hardware, instructions stored in memory or in another computer-readable medium and executed by a processor or other processing device, or combinations of both. The arbiters, master devices, and slave devices described herein may be employed in any circuit, hardware component, integrated circuit (IC), or IC chip, as examples. Memory disclosed herein may be any type and size of memory and may be configured to store any type of information desired. To clearly illustrate this interchangeability, various illustrative components, blocks, modules, circuits, and steps have been described above generally in terms of their functionality. How such functionality is implemented depends upon the particular application, design choices, and/or design constraints imposed on the overall system. Skilled artisans may implement the described functionality in varying ways for each particular application, but such implementation decisions should not be interpreted as causing a departure from the scope of the present invention.

The various illustrative logical blocks, modules, and circuits described in connection with the embodiments disclosed herein may be implemented or performed with a processor, a DSP, an Application Specific Integrated Circuit (ASIC), an FPGA or other programmable logic device, discrete gate or transistor logic, discrete hardware components, or any combination thereof designed to perform the functions described herein. A processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The embodiments disclosed herein may be embodied in hardware and in instructions that are stored in hardware, and may reside, for example, in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of computer readable medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a remote station. In the alternative, the processor and the storage medium may reside as discrete components in a remote station, base station, or server.

It is also noted that the operational steps described in any of the exemplary embodiments herein are described to provide examples and discussion. The operations described may be performed in numerous different sequences other than the illustrated sequences. Furthermore, operations described in a single operational step may actually be performed in a number of different steps. Additionally, one or more operational steps discussed in the exemplary embodiments may be combined. It is to be understood that the operational steps illustrated in the flow chart diagrams may be subject to numerous different modifications as will be readily apparent to one of skill in the art. Those of skill in the art would also understand that information and signals may be represented using any of a variety of different technologies and techniques. For example, data, instructions, commands, information, signals, bits, symbols, and chips that may be referenced throughout the above description may be represented by voltages, currents, electromagnetic waves magnetic fields or particles, optical fields or particles, or any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein, but is to be accorded the widest scope consistent with the principles and novel features disclosed herein.

What is claimed is:

1. An electronic device configured to operate using a M-PHY standard, comprising:
a communications interface having a plurality of data paths conforming to a M-PHY standard;
a USB connector having a plurality of pins comprising:
a first receive pin electrically coupled to a M-PHY RXDN data path of the communications interface;
a second receive pin electrically coupled to a M-PHY RXDP data path of the communications interface;
a first transmit pin electrically coupled to a M-PHY TXDN data path of the communications interface; and
a second transmit pin electrically coupled to a M-PHY TXDP data path of the communications interface.

2. The device of claim 1 wherein other pins of the plurality of pins are configured to allow insertion detection.

3. The device of claim 2 wherein a VBUS pin and a D+ pin are electrically coupled to facilitate insertion detection.

4. The device of claim 2 wherein a GND pin and a D− pin are electrically coupled to facilitate insertion detection.

5. The device of claim 2 wherein a D− pin and a D+ pin are electrically coupled to facilitate insertion detection.

6. The device of claim 1 wherein other pins of the plurality of pins are configured to provide power therethrough.

7. The device of claim 1 wherein other pins of the plurality of pins are configured to provide an additional data channel therethrough.

8. The device of claim 7 wherein a D+ pin and a D− pin of the other pins are configured to provide the additional data channel therethrough.

9. The device of claim 1 wherein the USB connector conforms to a USB 3.0 standard.

10. The device of claim 1 wherein the connector comprises an element selected from the group consisting of: a plug, a receptacle, and a plug with cable.

11. The device of claim 1 integrated into a semiconductor die.

12. The device of claim 1, further comprising a device selected from the group consisting of a set top box, an entertainment unit, a navigation device, a communications device, a fixed location data unit, a mobile location data unit, a mobile phone, a cellular phone, a computer, a portable computer, a desktop computer, a personal digital assistant (PDA), a monitor, a computer monitor, a television, a tuner, a radio, a satellite radio, a music player, a digital music player, a portable music player, a digital video player, a video player, a digital video disc (DVD) player, and a portable digital video player, into which the electronic device is integrated.

13. An electronic device configured to operate using a M-PHY standard, comprising:
means for interfacing the electronic device to another device, the interfacing means having a plurality of data paths conforming to the M-PHY standard;
a universal serial bus (USB) connecting means for connecting the interfacing means to the another device, the USB connecting means having a plurality of pins comprising:
a first receive pin electrically coupled to a M-PHY RXDN data path of the interfacing means;
a second receive pin electrically coupled to a M-PHY RXDP data path of the interfacing means;
a first transmit pin electrically coupled to a M-PHY TXDN data path of the interfacing means; and
a second transmit pin electrically coupled to a M-PHY TXDP data path of the interfacing means.

14. The device of claim 13 wherein the interfacing means comprises a communications interface.

15. The device of claim 13 wherein the means for connecting comprises a USB connector.

16. A method of connecting an electronic device configured to operate using a M PHY standard to a second device, comprising:
providing a plurality of data paths conforming to the M-PHY standard;
providing a USB connector having a plurality of pins;
electrically coupling a first receive pin to a M-PHY RXDN data path;
electrically coupling a second receive pin to a M-PHY RXDP data path;
electrically coupling a first transmit pin to a M-PHY TXDN data path of a communications interface; and
electrically coupling a second transmit pin to a M-PHY TXDP data path of the communications interface.

17. The method of claim 16 further comprising detecting insertion of the USB connector.

18. The method of claim 16 further comprising providing power through the USB connector.

19. The method of claim 16 further comprising providing an additional data channel over a D+ and a D− pin on the USB connector.

20. The method of claim 16 wherein providing the USB connector comprises providing a USB connector conforming to a USB 3.0 protocol.
